(19) United States
(12) Patent Application Publication
(10) Pub. No.: US 2018/0362295 A1
(43) Pub. Date: Dec. 20, 2018

(54) ELEVATOR SYSTEM HAVING USER INTERFACES WHICH CAN BE CONFIGURED VIA A LIGHT DETECTION UNIT, AND PORTABLE CONFIGURATION DEVICE

(71) Applicant: Inventio AG, Hergiswil (CH)

(72) Inventor: Vimal Patel, Parsippany, NJ (US)

(21) Appl. No.: 15/737,014

(22) PCT Filed: Jun. 7, 2016
(86) PCT No.: PCT/EP2016/062894

§ 371 Date: Dec. 15, 2017

(30) Foreign Application Priority Data
Jun. 16, 2015 (EP) 15172269.1

(51) Int. Cl. B66B 3/02; B66B 1/34; B66B 1/46

(52) U.S. Cl. CPC B66B 3/026; B66B 1/3407; B66B 2201/4638; B66B 1/468; B66B 2201/4615; B66B 1/3461

(57) ABSTRACT

An elevator system has a control system linked to a plurality of functional components and a plurality of individually configurable user interfaces. Each of the user interfaces has a light detection unit with a light sensor. A portable configuration device has a human-machine interface, a light source and a data processing unit that codes data entered by a user via the human-machine interface for controlling the light source to generate a sequence of lights of different brightnesses. This sequence of lights is detected by the light detection unit and converted into an item of information used to configure the user interface, for example, to transmit to the control system a position at which the user interface is located. Thus, the control system can clearly identify user interfaces that are connected in series.

### FIELD

The present invention relates to an elevator system. In particular, the invention relates to a variably configurable elevator system as well as a portable configuration device for configuring said elevator. Moreover, the invention relates to a computer program product for implementation on a programmable configuration device as well as a computer-readable medium that can store a computer program product of this type.

### BACKGROUND

Elevator systems typically have at least one car, which can be displaced between two floors.

Furthermore, elevator systems have multiple functional components, by means of whose functions the elevator system can be implemented and controlled. These functional components include, for instance, a motor that displaces the elevator car, an actuator unit that e.g. opens and closes the elevator door, or the like.

Additionally, an elevator system regularly comprises a plurality of user interfaces, by means of which a user who is using the elevator system can enter data into the elevator system and/or by means of which information can be transmitted from the elevator system to the user. For example, a user interface is generally provided in the car in the form of a car operating panel (COP). A user can use this COP to indicate to the elevator system the position to which the car should be displaced. The elevator system can also use the COP to indicate to the user where the car is currently located. Further functions of the elevator system could also possibly be initiated by the user by making an entry into the COP, or the functions could be displayed to the user via an output. So-called lobby operating panels (LOPs) could be provided on every floor, for example, as further user interfaces in the elevator system. Using the LOP, a user can request the car of the elevator system, for example, and possibly also indicate the direction in which he or she intends to travel. Furthermore, the LOP can often include a display to show the user the position at which the car is currently located.

The elevator system generally also has a control system, which is linked both to the functional components and to the user interfaces. The link between the control system, the functional components and the user interfaces can be implemented by means of wiring or else wirelessly and can be configured such that a user can enter an item of information into one of the user interfaces and said information is relayed to the control system, at which point the control system activates one of the functional components on the basis of the information to execute a function. Alternatively, the control system can relay information to the user interface, and the user interface can provide this information to the user.

For the most part, the multiple user interfaces of the elevator system are arranged at different positions within the elevator system and/or are configured in different configurations. Before the elevator system is brought into service or is set to correct working order, said system and its user interfaces must be suitably configured, and the position at which each of the user interfaces is located must be known.

There may therefore be a need, inter alia, for an elevator system that can be configured in a simple way, in particular its user interfaces. Furthermore, there may be a need for a portable configuration device and a method for using it, by means of which the elevator system can be configured in an advantageous way. Moreover, there may be a need for a computer program product as well as a computer-readable medium that can store a computer program product of this type in order to program a programmable configuration device in a suitable manner.

### SUMMARY

According to a first aspect of the invention, an elevator system is proposed which comprises a car, a plurality of functional components, a plurality of user interfaces and a control system. The control system is linked both with the functional components and with the user interfaces. The elevator system is distinguished by the fact that each of the user interfaces has a light detection unit with a light sensor.

According to a second aspect of the invention, a portable configuration device is proposed which has a human-machine interface (HMI), a light source and a data processing unit. The data processing unit in this case is configured to code data, which are entered by a user via the human-machine interface and which are intended to configure an elevator system, into control data for controlling the light source so that the light source can be used to generate a series of lights with different brightness levels, which code the configuration of the elevator system.

A third aspect of the invention relates to a configurable elevator system arrangement, which includes an embodiment of an elevator system according to the aforementioned first aspect of the invention and an embodiment of a portable configuration device according to the aforementioned second aspect of the invention.

A fourth aspect of the invention relates to a method for configuring a configurable elevator system arrangement according to the third aspect, having the steps: entering data, which are intended serve to configure an elevator system, into the human-machine interface of the portable configuration device; and arranging the portable configuration device such that a series of lights with different brightness levels, which are generated by the configuration device and which code the configuration of the elevator system, are oriented toward the light sensor of the light detection unit of the elevator system.

A fifth aspect of the invention relates to a computer program product, which contains machine-readable instructions that prompt a programmable configuration device to code data, which are entered by a user via the human-machine interface and which are intended to configure an elevator system, into control data for controlling the light source so that the light source can be used to generate a series of lights with different brightness levels, which code the configuration of the elevator system.

A sixth aspect of the invention relates to a computer-readable medium that has a computer program product saved on it according to the aforementioned fifth aspect of the invention.

Aspects and embodiments of the invention can be considered to be based, inter alia, upon the ideas and findings described below.

As was noted in the introduction, the multiple user interfaces of the elevator system are each arranged in different positions within the elevator system and/or are configured in different configurations. For example, an LOP can be provided as a user interface on each floor of a building served by the elevator system. Alternatively or additionally, an optical display unit, e.g. in the form of a display or a screen, can be provided in various positions, such as on every floor, so that the user can be shown e.g. a current position of the elevator car. Alternatively or additionally, an acoustic signal unit can also be provided as a user interface. A signal unit such as this can be configured as a loudspeaker, for instance, and can serve to audibly transmit information to the user about e.g. a current position of the car. Alternatively or additionally, the signal unit can have a microphone so that the user can provide information to the elevator system by means of acoustic instructions. The term “fixture” is often used for user interfaces of this type.

Before the elevator system is brought into service or during operation, the control system of the elevator system must generally be aware, for example, of the positions at which each of the user interfaces are arranged and/or the configuration in which these user interfaces are configured. For instance, the elevator system car could be displaced to a floor on which a user has requested the car only if the control system knows the location of the specific LOP actuated by the user.

Conventionally, the user interfaces are mostly configured in advance by installation or maintenance personnel. A suitable configuration option is often provided for this purpose in the interior of the user interface. For example, a hand wheel or a plug or switch can be used to configure information that indicates the position at which the respective user interface is arranged. Accordingly, suitable hardware must be provided in the user interface, which is associated with additional expenses. To configure the user interface, an installer must normally appropriately configure each individual interface of the elevator system before it is installed and possibly also open a housing of the interface in order to access the configuration option provided for this purpose. This regularly requires significant expenditures in labor and time.

An alternative possibility for configuring the user interfaces before their installation, i.e. already “ex works,” for example, would mean that an installer or maintenance personnel could no longer include standardized user interfaces that could be installed in different positions and/or in different configurations. Instead, the installer would have to include a user interface that had already been appropriately configured beforehand for every possible position and/or configuration. This would entail a significant logistical effort and material expense.

It is now proposed that each of the user interfaces of an elevator system be equipped with a light detection unit. The light detection unit should have at least one light sensor. Advantageously, the light detection unit can also have a signal processing unit, by means of which the signals of the light sensor can be processed. In this way, a plurality of user interfaces in the elevator system can be configured identically in terms of their hardware. For example, the light sensor can be provided as a cost-effective, simple semiconductor component, e.g. in the form of a photodiode.

According to one embodiment, the light detection unit is designed to detect an optical signal by means of its light sensor and to convert said signal into information, which is used to configure components of the elevator system, in particular the user interface with which the respective light detection unit is associated.

In other words, the light detection unit that is provided in the user interface can be used to configure the user interface by means of an optical signal generated outside of the user interface. The optical signal can be produced, for example, with the aid of the aforementioned portable configuration device. One way an installer can do so is by using the human-machine interface of the configuration device to enter the position and/or the configuration in which each user interface should be or has already been installed. The data processing unit of the configuration device can convert these data into control data for controlling the light source of the configuration device, and so the light source is ultimately activated so that it generates the optical signal that is to be detected by the light detection unit.

Utilizing the light detection unit that is designed in this way can open the possibility of configuring each individual user interface of the elevator system in a simple way. Since the light sensor can detect optical signals radiated inward from outside, it is not necessary to open a housing of the user interface, for example. The user interface can possibly already be installed in the position provided for it. A configuration of the user interface is very easily possible and can also be changed or corrected afterwards, i.e. after installation or a modification.

According to one embodiment, the optical signal is a predefined series of different brightness levels. In other words, the optical signal transmitted to configure the user interface can be a chronological sequence of light with different light intensities that is emitted by a light source. For instance, the optical signal can be a sequence of light pulses or light flashes of a predetermined duration or multiple different predetermined durations. Each individual light pulse can have different light intensities in this case. If only two different light intensities are possible, then a binary signal can be generated. The optical signal can thus be similar to an optical Morse code. This type of optical signal with brightness levels that differ in duration can be produced in a simple way and can be reliably recognized by a light sensor of a light detection unit.

According to a concrete embodiment, the user interfaces are arranged at different positions and/or in different configurations within the elevator system, and the light detection unit is designed to detect an optical signal by means of its light sensor and to convert said signal into information indicating the position and/or configuration of the associated user interface. The information about the position and/or configuration of the user interface can be stored within the elevator system and can thus be available to the control system of the elevator system as needed.

According to one embodiment, for example, each of the interfaces can have a storage unit to temporarily and/or permanently save the information that indicates the position and/or configuration. The user interface or the light detection unit provided within it can include a suitable electronic circuit, for instance, by means of which a signal emitted by the light sensor is initially converted into information that indicates the position and/or configuration of the user interface. This information can then be stored in a memory unit that is likewise provided in the electronic circuit, i.e. in a flash memory or a RAM (random access memory), so that it can be retrieved e.g. by the control system at a later point in time. Alternatively, the signal generated by the light sensor can be saved directly to the memory unit, especially when it is a digital signal, and can be converted to information describing the position and/or configuration of the user interface only later, as required.

According to one embodiment, the user interfaces are connected in series to the control system of the elevator system. In other words, the user interfaces are not all connected individually and in parallel with the control system, with each of the interfaces being linked to the control system by its own connector, for example, and the control unit thus being able to deduce a position and/or configuration of the associated user interfaces based on knowledge of each connector. Instead, the user interfaces are connected consecutively in series, and only a beginning and an end of this serial connection are linked to the control system. Thus, the control system cannot detect the position and/or configuration in which a given interface can be found simply on the basis of an association with the respective connectors. A serial connection of interfaces such as this can significantly reduce the complexity of the wiring within an elevator system. In such a case, however, information about the respective position and/or configuration of each of the plurality of user interfaces must be available to the control system. Because the user interfaces can be configured by means of the provided light detection device, as described herein, the elevator system and its control system can be provided with this information for each of the user interfaces in a simple way and, if necessary, can also be modified or corrected afterwards.

According to one embodiment, a further function can be implemented with the aid of the light detection units provided in the user interfaces. A user interface also includes an illuminated display unit. In this instance, the light detection unit and the display unit are designed to determine a light intensity relative to ambient light using the light sensor and to regulate the brightness of the display unit in response to the light intensity determined.

For example, the display unit can be a display that is provided with background illumination or a self-illuminating display, by means of which it can be possible to display on every floor e.g. where the car of the elevator system is currently located. Depending upon how bright it is in the vicinity of the display, its brightness can be adapted appropriately in order to ensure good readability but also to prevent excessive energy use or any disturbances caused by the illuminated display.

In a particularly advantageous embodiment, the portable configuration device is a mobile telephone, sometimes also called a cell phone or, in specific configurations, a smartphone. The light source provided to generate the optical signal here can be the telephone screen or a separate illumination source provided in the telephone, such as an LED flashlight. In this case, an installer would not have to bring a separate configuration device provided specifically for this purpose, but could instead configure the user interfaces of the elevator system using his or her mobile telephone, which people usually have with them these days, anyway.

The human-machine interface in this instance can be a keyboard on the telephone or its touch-sensitive screen (touchscreen), and the processors and memories in modern telephones can also perform the task of a data processing unit for the configuring device.

In particular, it can be advantageous according to one embodiment to make a programmable mobile telephone capable of serving the user as a portable configuration device with the aid of a computer program product in the form of an application (“app”). As software, an app of this type can be specifically adapted for different types of mobile telephones in order to utilize their hardware, e.g. a keyboard or a touchscreen of the mobile telephone, as a human-machine interface so that data can easily be entered for the configuration of the elevator system and its user interfaces. The data can then be processed by means of the processor hardware contained in the mobile telephone such that the screen or an LED flashlight can then be activated to emit series of light signals having different brightness levels.

A corresponding computer program product can be stored on a computer-readable medium such as a CD, a DVD, a flash memory or the like. The computer program product can also be stored on a computer and, for instance, be available to a mobile telephone as a downloadable app.

Within the scope of a method for configuring a configurable elevator system arrangement, a user can advantageously employ the portable configuration device to enter into the human-machine interface the data that are intended to configure the elevator system. The configuration device can then code these data into a series of lights with different levels of brightness. By arranging the portable configuration device such that the light series generated by the configuration device strikes the light sensor of the light detection device of the elevator system, the light series can be detected by the elevator system and the respective user interface and can be utilized to configure them.

In this way, a technician can configure the elevator system and its user interfaces very easily, quickly and, possibly, without special tools, instead employing only the suitable use of his or her mobile telephone, which serves as a portable configuration device.

It is noted that some of the possible features and advantages of the invention are described herein with reference to different embodiments. In particular, features and advantages are described, on the one hand, with reference to an elevator system and, on the other hand, with reference to a portable configuration device, which can be used to configure the user interfaces of the elevator system. The elevator system and the configuration device are suitably coordinated so that together they form a configurable elevator system arrangement, in which the ideas underlying the invention are implemented jointly. A person skilled in the art recognizes that the features of individual embodiments can be combined, adapted or exchanged in appropriate ways in order to arrive at further embodiments of the invention.

### DESCRIPTION OF THE DRAWINGS

Embodiments of the invention will be described below with reference to the accompanying drawings, wherein neither the drawings nor the description are to be interpreted as limiting the invention.

FIG. 1 illustrates an elevator system according to an embodiment of the present invention.

FIG. 2 illustrates a user interface of an elevator system as well as a portable configuration device according to embodiments of the present invention.

### DETAILED DESCRIPTION

The drawings are merely schematic and not true to scale. The same reference signs indicate the same or equivalent features.

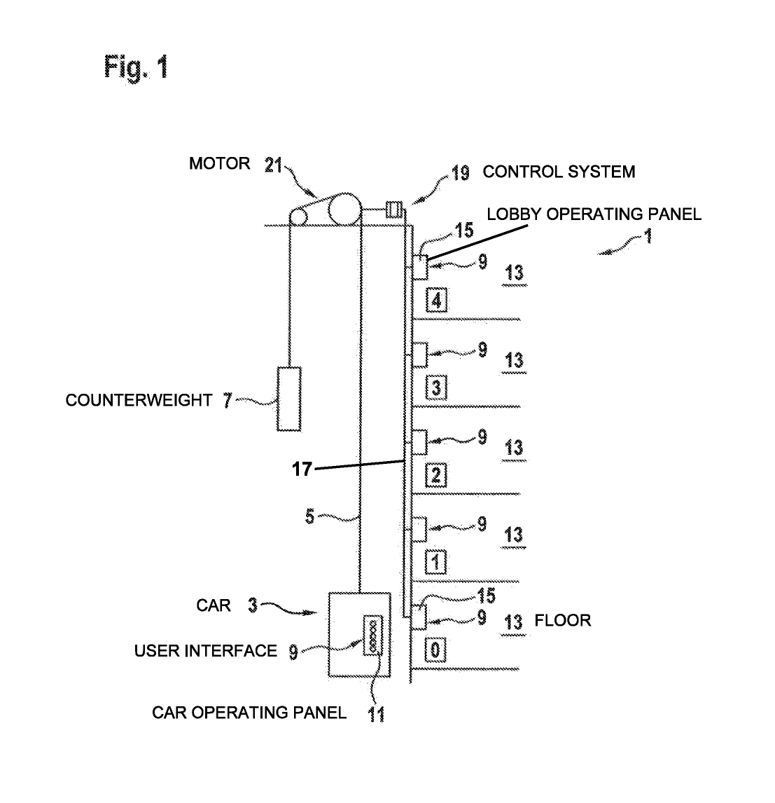

FIG. 1 illustrates an elevator system 1 according to an embodiment of the invention. The elevator system 1 has a car 3 and a counterweight 7, which is connected to the car 3 by a cable 5 or a strap.

In the car 3, a user interface 9 in the form of a car operating panel (COP) 11 is provided on the wall, by means of which a user located in the car 3 can request a function of the elevator system 1, such as displacing the car 3 to a desired destination floor 13.

A further user interface 9 in the form of a lobby operating panel (LOP) 15 is provided both on a wall on one of the floors 13 and next to an entrance to the car 3. Using one of the lobby operating panels 15, a user located outside of the car 3 on the floor 13 can request a function of the elevator system 1, such as displacing the car 3 to the floor 13 on which the user is currently located and is waiting for the car 3.

The car operating panel 11 and the lobby operating panel 15 relay signals representing the user's requests to the control system 19. To this end, the control system 19 is linked to the car operating panel 11 and to all lobby operating panels 15 via serial wiring 17. The control system 19 can thus recognize whether a user is currently making a request of the elevator system 1 via the car operating panel 11 or one of the lobby operating panels 15. The control system 19 then appropriately activates components of the elevator system, such as motor 21 driving the cable 5 or car door actuators, in order to carry out the functions requested by the user.

However, in order to precisely determine the floor 13 on which e.g. a user has actuated a lobby operating panel 15 and is thus waiting for the car 3, the control system 19 must be able to clearly identify each of the user interfaces 9. To do so, the floors 13 on which each of the user interfaces 9 are installed must be known. Corresponding information can then be forwarded to the control system 19 or be actively requested by it from the respective user interface 9. In this way, the control system 19 can always clearly identify from which of the user interfaces 9 a request e.g. for a car 3 originated, even when the user interfaces 9 are connected in series.

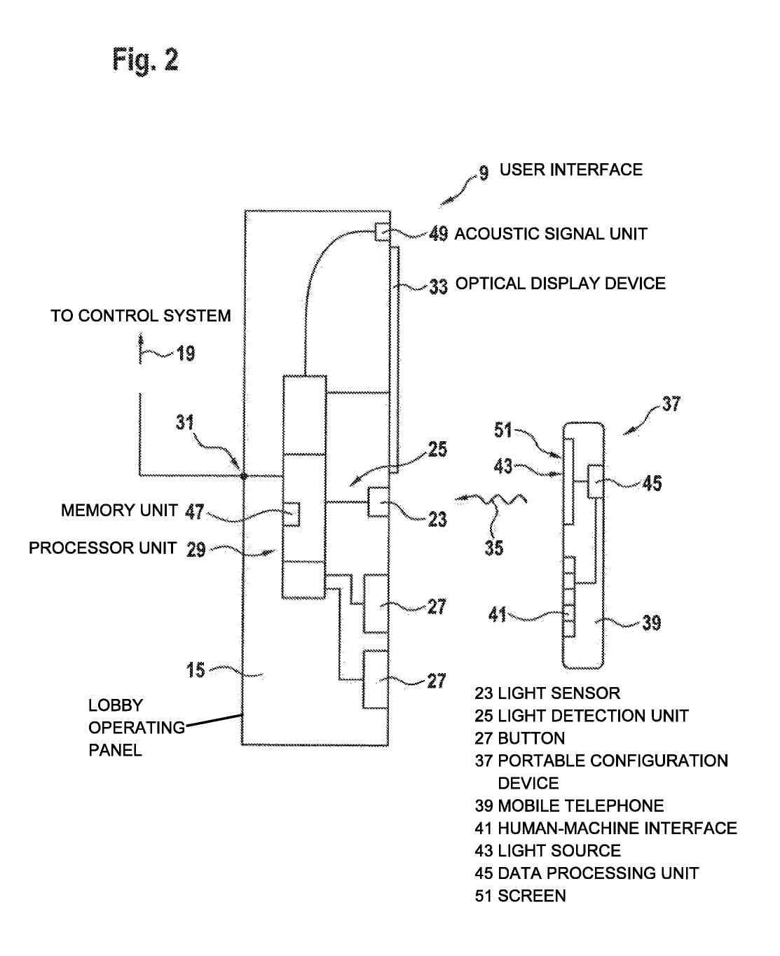

FIG. 2 illustrates a configuration of a user interface 9 in the form of a lobby operating panel 15 for a claimed elevator system 1. Similar to conventional lobby operating panels 15, the user interface 9 comprises two buttons 27, with which a user can request a car and simultaneously indicate the direction in which he or she wishes to travel. Additionally, the lobby operating panel 15 has an optical display device 33 in the form of an illuminated display, on which e.g. a current position of the car 3 or an expected waiting time can be shown. Furthermore, an acoustic signal unit 49 is provided in the form of a loudspeaker, by means of which an acoustic signal can be emitted in order to warm a user of the opening or closing of an elevator door, for example.

The buttons 27, the optical display unit 33 and the acoustic signal unit 49 are each linked with a processor unit 29, which receives corresponding signals e.g. from the buttons 27 or generates the signals for the optical display unit 33 and the acoustic signal unit 49. The processor unit 29 can communicate with the control system 19 via a data interface 31.

In addition, the user interface 9 has a light sensor 23, which is part of a light detection unit 25. The light sensor 23 can be a simple photodiode and be capable of detecting the intensity of light that reaches the light sensor 23 from an environment of the user interface 9 and to emit a corresponding signal. This signal is relayed to the processor unit 29, which comprises a specific circuit that is allocated to the light detection unit 25 for this purpose. The light detection unit 25 can thus evaluate the signal from the light sensor 23 and can convert it into information, for example, that indicates a position or a configuration of the user interface 9. This information can be stored in a memory unit 47.

To be able to transmit the desired information about their position and/or configuration to the user interface 9, an installer or maintenance personnel can carry a portable configuration device 37 with him or her.

Said configuration device 37 has a human-machine interface (HMI) 41, by means of which the installer can enter information. The human-machine interface 41 can be a keyboard, a touch-sensitive screen or the like.

The configuration device 37 further has a light source 43. The light source 43 can be a lamp, an LED or the like. The light source 43 can also be a screen 51. The brightness of the light source 43 can be adjusted variably. For example, the brightness of the light source 43 can be varied in two or more steps between a minimum and a maximum brightness. Alternatively, a step-less brightness variation can be provided.

The human-machine interface 41 and the light source 43 are linked to a data processing unit 45. This data processing unit 45 can receive and process data signals from the human-machine interface 41. For this purpose, a data set that an installer has entered into the human-machine interface 41 can be coded by the data processing unit 45 into control data. These control data are then used to appropriately activate the light source 43 so that, with the aid of said data, a chronological sequence of light with different light intensities can be generated as an optical signal 35. This sequence thus represents a coded form of the data set that is entered into the human-machine interface 41 and, as such, can easily be received and processed by the light sensor 23 of the light detection unit 25.

In this way, the installer or maintenance personnel can very easily enter position or configuration information into the configuration device 37, have said device convert it into a series of light pulses and thereby ultimately utilize it to configure the user interface 9. Doing so requires only that an inexpensive and easily installed light sensor 23 be provided in the user interface 9. In particular, the user interface 9 does not need to be opened or uninstalled in order to be configured.

The portable configuration device 37 can be a commercially available mobile telephone 39, for instance. In this case, the human-machine interface 41 can be a keyboard 41 or a touchscreen of the telephone 39. A screen 51 or the touchscreen can serve as a light source 43. Alternatively, an LED that otherwise works as a flashlight can be used as a light source 43. The electronics processor unit that is already present in the telephone 39 can be drawn upon to act as the data processing unit 45. On the whole, a commercially available mobile telephone can thus already contain all of the necessary hardware and, with the aid of software in the form of an app, can be rendered capable of implementing the desired functions of a configuration device 37.

Moreover, the light detection unit 25 can be employed with its light sensor 23 to recognize the current intensity of ambient light and to adjust the brightness of the optical display unit 33 appropriately.

In conclusion, it should be noted that terms like “having,” “comprising”, etc. do not exclude any other elements or steps, and terms like “a” or “an” do not exclude a plurality. Furthermore, it is noted that features or steps that have been described with reference to one of the aforementioned embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. An elevator system, comprising:
a car;
a plurality of functional components;
a plurality of user interfaces;
a control system for controlling movement of the car, the control system being connected to the functional components and to the user interfaces; and
wherein each of the user interfaces is responsive to an optical signal for configuring the user interfaces to enable the control system to individually identify each of the user interfaces.

17. The elevator system according to claim 16 wherein each of the user interfaces includes a light detection unit with a light sensor for detecting the optical signal with the light sensor and for converting the optical signal into information for configuring the user interface.

18. The elevator system according to claim 17 wherein the optical signal includes a predefined series of different brightness levels.

19. The elevator system according to claim 17 wherein the user interfaces are arranged in at least one of different positions and different configurations within the elevator system, and wherein the information converted by the light detection units from the optical signal indicates at least one of a position and a configuration of an associated one of the user interfaces.

20. The elevator system according to claim 19 wherein the user interfaces have a memory unit for storing the information that indicates at least one of the position and the configuration.

21. The elevator system according to claim 16 wherein the user interfaces are serially connected to the control system.

22. The elevator system according to claim 16 wherein each of the user interfaces is one of a car operating panel, a lobby operating panel, an optical display device and an acoustic signal unit.

23. The elevator system according to claim 16 wherein at least one of the user interfaces has an illuminated optical display device connected to a light detection unit with a light sensor, and the optical display unit determines a light intensity relative to ambient light using the light sensor and regulates a brightness of the optical display device in response to the determined light intensity.

24. A portable configuration device, comprising:
a human-machine interface;
a light source; and
a data processing unit configured to code data, which data are entered by a user via the human-machine interface and are intended to configure an elevator system, into control data for controlling the light source to generate a series of lights with different brightness levels as an optical signal to configure the elevator system.

25. The portable configuration device according to claim 24 being a mobile telephone and wherein the light source is a screen or a separate illumination source of the mobile telephone.

26. A configurable elevator system including the portable configuration device according to claim 24 and further comprising:
a car;
a plurality of functional components;
a plurality of user interfaces;
a control system for controlling movement of the car, the control system being connected to the functional components and to the user interfaces; and
wherein each of the user interfaces is responsive to the optical signal for configuring the user interfaces to enable the control system to individually identify each of the user interfaces.

27. A method for configuring the configurable elevator system according to claim 26 comprising the steps of:
entering the data intended to configure the elevator system into the human-machine interface of the portable configuration device; and
positioning the portable configuration device such that the generated optical signal is oriented toward a light sensor of a light detection unit included in a one of the user interfaces associated with the data.

28. A computer program product comprising machine-readable instructions that, when loaded into a data processing unit of a programmable configuration device, code data, which data are entered by a user via a human-machine interface of the configuration device for configuring an elevator system, into control data for controlling a light source of the configuration device to generate a series of lights with different brightness levels as an optical signal to be used to configure the elevator system.

29. The computer program product according to claim 28 wherein the computer program product is a software application and the configuration device is a mobile telephone.

30. A non-transitory computer-readable medium that has the computer program product according to claim 28 stored thereon.
